(19) United States
(12) Patent Application Publication
(10) Pub. No.: US 2007/0276082 A1
(43) Pub. Date: Nov. 29, 2007

(54) POLY(ARYLENE ETHER) COMPOSITION, METHOD, AND ARTICLE

(76) Inventors: Kim Balfour, Delanson, NY (US); Vijay Mhetar, Slingerlands, NY (US)

Correspondence Address: CANTOR COLBURN LLP - GE PLASTICS-NORYL, 55 GRIFFIN ROAD SOUTH, BLOOMFIELD, CT, 06002, US

(21) Appl. No.: 11/420,081

(22) Filed: May 24, 2006

(51) Int. Cl. C08L 53/00

(52) U.S. Cl. 524/505

(57) ABSTRACT

A poly(arylene ether) composition exhibiting an improved balance of stiffness, ductility, and heat resistance is prepared by melt-kneading a poly(arylene ether), an acid-functionalized block copolymer, and a polyamine compound.

### BACKGROUND OF THE INVENTION

Poly(arylene ether) resins and their blends with nonelastomeric polystyrene resins are highly valued for their balance of properties including stiffness, impact strength, heat resistance, and electrical resistivity. There is a longstanding need for poly(arylene ether) resins and resin blends with improved balance of ductility, stiffness, and heat resistance. One approach to improving ductility is to blend the poly(arylene ether) resin with styrenic impact modifiers such as polystyrene-polybutadiene-polystyrene triblock copolymers (SBS), polystyrene-poly(ethylene-butylene)-polystyrene triblock copolymers (SEBS), or rubber-modified polystyrenes (sometimes called “high impact polystyrenes” or “HIPS”). However addition of these impact modifiers generally reduces stiffness and heat resistance. Accordingly, there remains a need for poly(arylene ether) blends that offer improved balances of ductility, stiffness, and heat resistance.

### BRIEF DESCRIPTION OF THE INVENTION

Surprisingly, it has been found that an excellent balance of ductility, stiffness, and heat resistance is exhibited by blends of poly(arylene ether) resins with acid-functionalized block copolymers that have been crosslinked using a polyamine compound. Thus, one embodiment is a composition comprising the product obtained on melt-kneading a poly(arylene ether), an acid-functionalized block copolymer of an alkenyl aromatic monomer and a conjugated diene, and a polyamine compound.

Another embodiment is a composition comprising the product obtained on melt-kneading a poly(arylene ether) comprising 2,6-dimethyl-1,4-phenylene ether units, 2,3,6-trimethyl-1,4-phenylene ether units, or a combination thereof; a maleic-anhydride functionalized, hydrogenated block copolymer comprising at least one polystyrene block and at least one hydrogenated poly(conjugated diene) block, and having a styrene content of about 10 to about 50 weight percent and a bound maleic anhydride content of about 0.2 to about 5 weight percent; and a polyethyleneimine having a number average molecular weight of about 100 to about 10,000 atomic mass units.

Another embodiment is a composition comprising the product obtained on melt-kneading about 50 to about 95 parts by weight of a poly(arylene ether) comprising 2,6-dimethyl-1,4-phenylene ether units, 2,3,6-trimethyl-1,4-phenylene ether units, or a combination thereof; about 5 to about 50 parts by weight of a maleic-anhydride functionalized block copolymer selected from the group consisting of polystyrene-poly(ethylene-butylene)-polystyrene triblock copolymer, polystyrene-poly(ethylene-propylene)-polystyrene triblock copolymer, and mixtures thereof; wherein the maleic-anhydride functionalized block copolymer has a styrene content of about 10 to about 50 weight percent and a bound maleic anhydride content of about 0.2 to about 5 weight percent; and about 0.02 to about 2 parts by weight of a polyethyleneimine having a number average molecular weight of about 100 to about 10,000 atomic mass units; wherein all parts by weight are based on 100 parts by weight total of the poly(arylene ether) and the maleic-anhydride functionalized block copolymer.

Other embodiments include compositions suitable for melt-kneading. Thus, one embodiment is a composition comprising a poly(arylene ether), an acid-functionalized block copolymer of an alkenyl aromatic monomer and a conjugated diene, and a polyamine compound.

Other embodiments include methods of melt-kneading such compositions. Thus, one embodiment is a method of preparing a composition, comprising melt-kneading a poly(arylene ether), an acid-functionalized block copolymer of an alkenyl aromatic monomer and a conjugated diene, and a polyamine compound.

Other embodiments, including articles formed from the melt-kneaded compositions, are described in detail below.

### BRIEF DESCRIPTION OF THE DRAWINGS

FIG. 1 is a transmission electron micrograph of a composition obtained on melt-kneading a poly(arylene ether) and an acid-functionalized block copolymer, but no polyamine compound.

FIG. 2 is a transmission electron micrograph of a composition obtained on melt-kneading a poly(arylene ether), an acid-functionalized block copolymer, and a polyamine compound.

### DETAILED DESCRIPTION OF THE INVENTION

One embodiment is a composition comprising the product obtained on melt-kneading a poly(arylene ether), an acid-functionalized block copolymer of an alkenyl aromatic monomer and a conjugated diene, and a polyamine compound. Relative to compositions without the polyamine compound, the compositions described herein may exhibit improved stiffness, and heat resistance, and may further exhibit improved ductility. For example, the composition may exhibit one or more of a flexural modulus of at least 1400 megapascals, more specifically about 1400 to about 2000 megapascals, measured at 23° C. according ASTM D 790; a heat deflection temperature of at least 165° C., more specifically about 165 to about 180° C., measured according to ASTM D 648; and a dispersed phase having a number average particle diameter of about 0.1 to about 2 micrometers.

One of the components that is melt-kneaded is a poly(arylene ether). In some embodiments, the poly(arylene ether) comprises repeating structural units having the formula

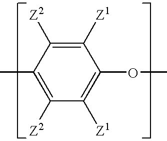

wherein for each structural unit, each Z¹ is independently halogen, unsubstituted or substituted C₁-C₁₂ hydrocarbyl with the proviso that that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. However, when the hydrocarbyl residue is described as “substituted”, may contain heteroatoms over and above the carbon and hydrogen members of the substituent residue. Thus, when specifically described as substituted, the hydrocarbyl residue may also contain halogen atoms, nitro groups, cyano groups, carbonyl groups, carboxylic acid groups, ester groups, amino groups, amide groups, sulfonyl groups, sulfoxyl groups, sulfonamide groups, sulfamoyl groups, hydroxyl groups, alkoxyl groups, or the like, and it may contain heteroatoms within the backbone of the hydrocarbyl residue.

In some embodiments, the poly(arylene ether) comprises 2,6-dimethyl-1,4-phenylene ether units, 2,3,6-trimethyl-1,4-phenylene ether units, or a combination thereof.

The poly(arylene ether) may comprise molecules having aminoalkyl-containing end group(s), typically located in a position ortho to the hydroxy group. Also frequently present are tetramethyldiphenoquinone (TMDQ) end groups, typically obtained from reaction mixtures in which tetramethyldipbenoquinone by-product is present. The poly(arylene ether) may be in the form of a homopolymer, a copolymer, a graft copolymer, an ionomer, or a block copolymer, as well as combinations thereof.

In one embodiment, the composition is substantially free of acid- or anhydride-functionalized poly(arylene ether). As used herein, when the composition is described as being “substantially free” of a component, the term “substantially free” means that the composition comprises less than 0.5 weight percent of the specified component. More specifically, the composition may comprise less than 0.1 weight percent of the specified component, or none of the specified component may be intentionally added. In another embodiment, the composition comprises an acid- or anhydride-functionalized poly(arylene ether), such as maleic anhydride-functionalized poly(arylene ether), but the amount of the acid- or anhydride-functionalized poly(arylene ether) is small enough not to substantially interfere with the processability of the composition.

There is no particular limitation on the molecular weight or molecular weight distribution of the poly(arylene ether). In one embodiment, the poly(arylene ether) has an initial intrinsic viscosity of about 0.05 to about 1.0 deciliter per gram, measured at 25° C. in chloroform. Initial intrinsic viscosity is defined as the intrinsic viscosity of the poly(arylene ether) prior to melt-kneading with the other components of the composition. The viscosity of the poly(arylene ether) may be up to 30% higher after melt-kneading. Within this above range of about 0.05 to about 1.0 deciliter per gram, the poly(arylene ether) may have an initial intrinsic viscosity of at least about 0.1 deciliter per gram, or at least about 0.2 deciliter per gram, or at least about 0.3 deciliter per gram. Also within this range, the poly(arylene ether) may have an initial intrinsic viscosity of up to about 0.8 deciliter per gram, or up to about 0.6 deciliter per gram.

In addition to the poly(arylene ether), the composition subjected to melt-kneading comprises an acid-functionalized block copolymer of an alkenyl aromatic monomer and a conjugated diene. In some embodiments, the acid-functionalized block copolymer is the product of functionalizing an unhydrogenated or hydrogenated block copolymer of an alkenyl aromatic compound and a conjugated diene with a functionalizing agent that is an acid or an acid anhydride. Suitable functionalizing agents include, for example, maleic acid, maleic anhydride, methyl maleic acid, methyl maleic anhydride, dimethyl maleic acid, dimethyl maleic anhydride, monochloro maleic acid, monochloro maleic anhydride, dichloro maleic acid, dichloro maleic anhydride, 5-norbornene-2,3-dicarboxylic acids, 5-norbornene-2,3-dicarboxylic acid anhydrides, tetrahydrophthalic acids, tetrahydrophthalic anhydrides, fumaric acid, itaconic acid, itaconic anhydride, citraconic acid, citraconic anhydride, trimellitic acid, trimellitic acid anhydride, trimellitic anhydride acid chloride, and the like, and mixtures thereof.

The acid-functionalized block copolymer is prepared from an unfunctionalized block copolymer precursor. As used herein, “block copolymer” refers to a single block copolymer or a combination of block copolymers. The block copolymer comprises at least one block (A) comprising repeating aryl alkylene units derived from an alkenyl aromatic monomer and at least one block (B) comprising repeating alkylene units derived from a conjugated diene monomer. The arrangement of blocks (A) and (B) may be a linear structure (including so-called tapered block copolymers) or a radial teleblock structure having branched chains. A-B-A triblock copolymers have two blocks A comprising repeating aryl alkylene units. A-B diblock copolymers have one block A comprising repeating aryl alkylene units. The pendant aryl moiety of the aryl alkylene units may be monocyclic or polycyclic and may have a substituent at any available position on the cyclic portion. Suitable substituents include C₁-C₄ alkyl groups. An exemplary aryl alkylene unit is a phenyl-substituted dimethylene unit (—CH(Ph)CH₂—) derived from styrene. Block A may further comprise C₂-C₁₅ alkylene units as long as the mole fraction of aryl alkylene units exceeds the mole fraction of alkylene units.

Block B comprises repeating C₂-C₁₅ alkylene units such as ethylene (dimethylene), propylene, butylene, or combinations of two or more of the foregoing. Block B may further comprise aryl alkylene units as long as the mole fraction of alkylene units exceeds the mole fraction of aryl alkylene units. Each occurrence of block A may have a molecular weight which is the same or different than other occurrences of block A. Similarly each occurrence of block B may have a molecular weight which is the same or different than other occurrences of block B.

In one embodiment, the B block comprises a copolymer of aryl alkylene units and C₂-C₁₅ alkylene units such as ethylene, propylene, butylene, or combinations of two or more of the foregoing. The B block may further comprise some unsaturated carbon-carbon bonds. The B block may be a controlled distribution copolymer. As used herein “controlled distribution” is defined as referring to a molecular structure lacking well-defined blocks of either monomer, with “runs” of any given single monomer attaining a maximum number average of 20 units as shown by either the presence of only a single glass transition temperature (T_{g}), intermediate between the Tg of either homopolymer, or as shown via proton nuclear magnetic resonance methods. Each A block may have an average molecular weight of about 3,000 to about 60,000 g/mol and each B block may have an average molecular weight of about 30,000 to about 300,000 g/mol. Each B block comprises at least one terminal region adjacent to an A block that is rich in alkylene units and a region not adjacent to the A block that is rich in aryl alkylene units. The total amount of aryl alkylene units is 15 to 75 weight percent, based on the total weight of the block copolymer. The weight ratio of alkylene units to aryl alkylene units in the B block may be 5:1 to 1:2. Exemplary block copolymers are further disclosed in U.S. Patent Application No. US 2003/181584 A1 of Handlin et al. International Patent Application No. WO 2003/66696 A1 of Handlin et al. Suitable controlled distribution block copolymers are also commercially available from Kraton Polymers as KRATON® A-RP6936 and KRATON® A-RP6935.

The repeating aryl alkylene units result from the polymerization of aryl alkylene monomers such as styrene, chlorostyrenes such as p-chlorostyrene, methylstyrenes such as alpha-methylstyrene and p-methylstyrene, and combinations thereof. The repeating alkylene units result from the hydrogenation of repeating unsaturated units derived from a conjugated diene such as 1,3-butadiene, 2-methyl-1,3-butadiene (isoprene), 2-chloro-1,3-butadiene (chloroprene), 2,3-dimethyl-1,3-butadiene, 1,3-pentadiene, 1,3-hexadiene, and combinations thereof. The conjugated diene may polymerize via 1,4 addition and/or 1,2 addition. Thus, when the conjugated diene polymerizes via 1,4 addition, the B block may contain in-chain aliphatic carbon-carbon double bonds, and when the conjugated diene polymerizes via 1,2 addition, the B block may contain pendant aliphatic carbon-carbon double bonds.

Exemplary block copolymers include polystyrene-poly(ethylene/propylene), polystyrene-poly(ethylene/propylene)-polystyrene, polystyrene-poly(ethylene/butylene), and polystyrene-poly(ethylene/butylene)-polystyrene.

The acid-functionalized block copolymer may be prepared by graft-reacting an acid moiety or its derivative onto the hydrogenated block copolymer via a free radically initiated reaction. Suitable monomers that may be grafted include unsaturated mono- and polycarboxylic acids and anhydrides containing from about 3 to about 20 carbon atoms. Examples of such monomers are maleic acid, maleic anhydride, methyl maleic acid, methyl maleic anhydride, dimethyl maleic acid, dimethyl maleic anhydride, monochloro maleic acid, monochloro maleic anhydride, dichloro maleic acid, dichloro maleic anhydride, 5-norbornene-2,3-dicarboxylic acids, 5-norbornene-2,3-dicarboxylic acid anhydrides, tetrahydrophthalic acids, tetrahydrophthalic anhydrides, fumaric acid, itaconic acid, itaconic anhydride, citraconic acid, citraconic anhydride, trimellitic acid, trimellitic acid anhydride, trimellitic anhydride acid chloride, and mixtures thereof. In one embodiment, the grafting monomer is maleic anhydride. The grafted polymer will usually contain about 0.1 to about 10 weight percent of the grafted monomer, specifically about 0.2 to about 5 weight percent of the grafted monomer.

The grafting reaction can be carried out in solution or by melt-mixing the base block copolymer and the acid/anhydride monomer in the presence of a free radical initiator. Solution processes are described, for example, in U.S. Pat. Nos. 4,033,888 and 4,077,893 to Kiovsky, and 4,670,173 to Hayashi et al. Melt-mixing processes are described, for example, in U.S. Pat. Nos. 4,427,828 to Hergenrother et al., 4,578,429 to Gergen et al., and 4,628,072 and 4,657,971 to Shiraki et al. Suitable acid-functionalized block polymers are also commercially available as, for example, KRATON® FG1901 and KRATON® FG1924 from Kraton Polymers.

In some embodiments, the acid-functionalized block copolymer is a maleic anhydride-functionalized linear block copolymer or radial teleblock copolymer of styrene and a conjugated diene selected from the group consisting of butadiene, isoprene, and combinations thereof, wherein the an acid-functionalized block copolymer has a styrene content of about 10 to about 50 weight percent.

In some embodiments, the acid-functionalized block copolymer is a maleic anhydride-functionalized polystyrene-poly(ethylene-butylene)-polystyrene triblock copolymer having a styrene content of about 10 to about 50 weight percent or a maleic anhydride-functionalized polystyrene-poly(ethylene-butylene) diblock copolymer having a styrene content of about 10 to about 50 weight percent.

The composition subjected to melt-kneading comprises a polyamine compound. A polyamine compound is a compound that comprises at least three amine groups that may be primary amine groups, secondary amine groups, or a combination thereof. In one embodiment, the polyamine compound may comprise, in addition to the at least three amine groups, alkylene groups that may optionally be substituted with catenary (in-chain) ether oxygen atoms. In one embodiment, the polyamine compound is free of carbonyl groups; in this embodiment, the polyamine is defined to exclude polyamides, polyamideimides, polyimides, and other carbonyl-containing compounds. In some embodiments, the polyamine may comprise at least four amine groups, or at least five amine groups, or at least six amine groups, or at least seven amine groups.

In some embodiments, the polyamine compound comprises (a) at least three amine groups selected from the group consisting of primary amine groups, secondary amine groups, and combinations thereof, and (b) at least one C₂-C₆ alkylene group optionally substituted with one or more ether oxygen atoms.

In one embodiment, the polyamine compound has a boiling point of at least about 120° C., more specifically at least about 150° C., still more specifically at least about 180° C. Such a boiling point facilitates efficient melt-kneading of the composition by reducing the amount of polyamine compound that is lost via volatilization before reacting with the acid-functionalized block copolymer.

In some embodiments, the polyamine compound is chosen from polyetheramines, polyalkyleneimines, polyalkyleneamines, and mixtures thereof.

In one embodiment, the polyamine compound is a polyetheramine. Polyetheramines are oligomeric or polymeric molecules comprising repeating alkylene ether units and at least two primary amine termini. Suitable polyetheramines include those having the structure

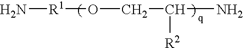

wherein R¹ is C₂-C₁₂ hydrocarbylene, more specifically C₂-C₆ alkylene, still more specifically —CH₂CH₂— or —CH(CH₃)CH₂—; each occurrence of R² is independently hydrogen or methyl; and q is 1 to about 100. Commercially available examples of such polyetheramines include XTJ-505, XTJ-506, XTJ-507, JEFFAMINE® M-2070, JEFFAMINE® D-230, JEFFAMINE® D-400, JEFFAMINE® D-2000, XTJ-500, XTJ-501, XTJ-502, XTJ-510, and JEFFAMINE® EDR-148, all from Huntsman. Suitable polyetheramines further include those having the structure

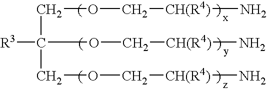

wherein R³ is hydrogen or C₁-C₁₂ hydrocarbyl, more specifically C₁-C₆ alkyl; each occurrence of R⁴ is independently hydrogen or methyl; and x and y and z are each independently 1 to about 100. Commercially available examples of such polyetheramines include JEFFAMINE® T-403, JEFFAMINE® T-5000, and XTJ-509, all from Huntsman.

In one embodiment, the polyamine compound is a polyalkyleneimine. Polyalkyleneimines can be prepared by polymerizing an alkylene imine (e.g., ethyleneimine, also known as aziridine) in the presence of a catalyst such as carbon dioxide, sodium bisulfite, sulfuric acid, hydrogen peroxide, hydrochloric acid, acetic acid, or the like. Specific methods for preparing polyalkyleneimines are described, for example, in U.S. Pat. Nos. 2,182,306 to Ulrich et al., 3,033,746 to Mayle et al., 2,208,095 to Esselmann et al., 2,806,839 to Crowther, and 2,553,696 to Wilson. In addition to linear and branched polyalkyleneimines, the present invention also includes the cyclic amines that are typically formed as by-products of known synthetic methods. The presence of these materials may be increased or decreased depending on the reaction conditions. Suitable polyalkyleneimines are commercially available as, for example, the polyethyleneimines EPOMIN® SP-003 (about 300 atomic mass units), EPOMIN® SP-006 (about 600 atomic mass units), EPOMIN® SP-012 (about 1200 atomic mass units), EPOMIN® SP-18 (about 1800 atomic mass units), EPOMIN® SP-200 (about 10,000 atomic mass units), EPOMIN® P-1000 (about 70,000 atomic mass units), and EPOMIN® P-1050 (about 70,000 atomic mass units), all from Nippon Shokubai. Commercially available polyalkyleneimines further include the polyethyleneimines LUPASOL FG (about 800 atomic mass units), LUPASOL G20 (about 1,300 atomic mass units), and LUPASOL G35 (about 2,000 atomic mass units), all from BASF.

In one embodiment, the polyamine compound is a polyalkyleneamine. Polyalkyleneamines may be prepared by the reaction of an alkylene dichloride (e.g., ethylene-1,2-dichloride) with ammonia, followed by fractional distillation. Examples of polyalkyleneamines are triethylene tetraamine, tetraethylenepentamine, and tetrabutylenepentamine, as well as the corresponding hexamines, heptamines, octamines, and nonamines. These compound or mixtures of compound may further comprise small amounts of reaction by-products, including cyclic amines, particularly piperazines, and cyclic amines with nitrogen-containing side chains. Mixtures of different polyalkyleneamines may be used. Preparation of polyalkyleneamines is described, for example, in U.S. Pat. No. 2,792,372 to Dickson.

In one embodiment, the polyamine compound may have a number average molecular weight of about 100 to about 1,000,000 atomic mass units. Within this range, the molecular weight may be at least about 200 atomic mass units, or at least about 300 atomic mass units. Also within this range, the molecular weight may be up to about 500,000 atomic mass units, or up to about 100,000 atomic mass units, or up to about 10,000 atomic mass units, or up to about 2,000 atomic mass units.

The poly(arylene ether), the acid-functionalized block copolymer, and the polyamine compound may be melt-kneading in proportions that provide the desired property balance. For example, in one embodiment, the composition before melt-kneading comprises about 20 to about 99 parts by weight of the poly(arylene ether), about 1 to about 80 parts by weight of the acid-functionalized block copolymer, and about 0.01 to about 5 parts by weight of the polyamine compound, wherein all parts by weight are based on 100 parts by weight total of the poly(arylene ether) and the acid-functionalized block copolymer. Within the above range of about 20 to about 99 parts by weight, the poly(arylene ether) amount may be at least about 50 parts by weight, or at least about 80 parts by weight, or up to about 95 parts by weight, or up to about 90 parts by weight. Within the above range of about 1 to about 80 parts by weight, the amount of acid-functionalized block copolymer may be at least about 5 parts by weight, or at least about 10 parts by weight, or up to about 50 parts by weight, or up to about 20 parts by weight. With the above range of about 0.01 to about 5 parts by weight, the polyamine compound amount may be at least about 0.1 part by weight, or at least about 0.2 part by weight, or up to about 3 parts by weight, or up to about 2 parts by weight, or up to about 1 part by weight.

In some embodiments, the composition before melt-kneading further comprises an atactic homopolystyrene, a rubber-modified polystyrene, or a mixture thereof.

The composition may, optionally, further comprise one or more fillers, including low-aspect ratio fillers, fibrous fillers, and polymeric fillers. Examples of such fillers well known to the art include those described in “Plastic Additives Handbook, 4^{th} Edition” R. Gachter and H. Muller (eds.), P. P. Klemchuck (assoc. ed.) Hansen Publishers, New York 1993. Non-limiting examples of fillers include silica powder, such as fused silica, crystalline silica, natural silica sand, and various silane-coated silicas; boron-nitride powder and boron-silicate powders; alumina and magnesium oxide (or magnesia); wollastonite including surface-treated wollastonite; calcium sulfate (as, for example, its anhydride, dihydrate or trihydrate); calcium carbonates including chalk, limestone, marble and synthetic, precipitated calcium carbonates, generally in the form of a ground particulate which often comprises 98+% CaCO₃ with the remainder being other inorganics such as magnesium carbonate, iron oxide and alumino-silicates; surface-treated calcium carbonates; talc, including fibrous, modular, needle shaped, and lamellar talcs; glass spheres, both hollow and solid, and surface-treated glass spheres typically having coupling agents such as silane coupling agents and/or containing a conductive coating; kaolin, including hard, soft, calcined kaolin, and kaolin comprising various coatings known to the art to facilitate the dispersion in and compatibility with the thermoset resin; mica, including metallized mica and mica surface treated with aminosilanes or acryloylsilanes coatings to impart good physicals to compounded blends; feldspar and nepheline syenite; silicate spheres; flue dust; cenospheres; fillite; aluminosilicate (armospheres), including silanized and metallized aluminosilicate; quartz; quartzite; perlite; Tripoli; diatomaceous earth; silicon carbide; molybdenum sulfide; zinc sulfide; aluminum silicate (mullite); synthetic calcium silicate; zirconium silicate; barium titanate; barium ferrite; barium sulfate and heavy spar; particulate or fibrous aluminum, bronze, zinc, copper and nickel; carbon black, including conductive carbon black; graphite, such as graphite powder; flaked fillers and reinforcements such as glass flakes, flaked silicon carbide, aluminum diboride, aluminum flakes, and steel flakes; processed mineral fibers such as those derived from blends comprising at least one of aluminum silicates, aluminum oxides, magnesium oxides, and calcium sulfate hemihydrate; natural fibers including wood flour, cellulose, cotton, sisal, jute, starch, cork flour, lignin, ground nut shells, corn, rice grain husks; synthetic reinforcing fibers, including polyester fibers such as polyethylene terephthalate fibers, polyvinylalcohol fibers, aromatic polyamide fibers, polybenzimidazole fibers, polyimide fibers, polyphenylene sulfide fibers, polyether ether ketone fibers, boron fibers, ceramic fibers such as silicon carbide, fibers from mixed oxides of aluminum, boron and silicon; single crystal fibers or “whiskers” including silicon carbide fibers, alumina fibers, boron carbide fibers, iron fibers, nickel fibers, copper fibers; glass fibers, including textile glass fibers such as E, A, C, ECR, R, S, D, and NE glasses, and quartz; vapor-grown carbon fibers including single-wall fibers, multi-wall fibers, and fibers having an average diameter of about 3.5 to about 500 nanometers as described in, for example, U.S. Pat. Nos. 4,565,684 and 5,024,818 to Tibbetts et al., 4,572,813 to Arakawa; 4,663,230 and 5,165,909 to Tennent, 4,816,289 to Komatsu et al., 4,876,078 to Arakawa et al., 5,589,152 to Tennent et al., and 5,591,382 to Nahass et al.; and the like. The above fillers may be used with various coatings, including, for example, metallic coatings and silane coating, to improve compatibility with and adhesion to the composition.

The composition may, optionally, further comprise various additives known in the thermoplastics art. For example, the composition may, optionally, further comprising an additive chosen from stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and the like, and combinations thereof. Additives may be added in amounts that do not unacceptably detract from the desired physical properties of the composition.

In one embodiment, the composition is substantially free of any thermoplastic or thermoset resin other than those described above. For example, the composition may be substantially free of an epoxy resin. As other examples, the composition may be substantially free of polyolefin, substantially free of polyamide, or substantially free of syndiotactic polystyrene.

One embodiment is a composition comprising the product obtained on melt-kneading a poly(arylene ether) comprising 2,6-dimethyl-1,4-phenylene ether units, 2,3,6-trimethyl-1,4-phenylene ether units, or a combination thereof; a maleic-anhydride functionalized, hydrogenated block copolymer comprising at least one polystyrene block and at least one hydrogenated poly(conjugated diene) block, and having a styrene content of about 10 to about 50 weight percent and a bound maleic anhydride content of about 0.2 to about 5 weight percent; and a polyethyleneimine having a number average molecular weight of about 100 to about 10,000 atomic mass units.

One embodiment is a composition comprising the product obtained on melt-kneading about 50 to about 95 parts by weight of a poly(arylene ether) comprising 2,6-dimethyl-1,4-phenylene ether units, 2,3,6-trimethyl-1,4-phenylene ether units, or a combination thereof; about 5 to about 50 parts by weight of a maleic-anhydride functionalized block copolymer selected from the group consisting of polystyrene-poly(ethylene-butylene)-polystyrene triblock copolymer, polystyrene-poly(ethylene-propylene)-polystyrene triblock copolymer, and mixtures thereof; wherein the maleic-anhydride functionalized block copolymer has a styrene content of about 10 to about 50 weight percent and a bound maleic anhydride content of about 0.2 to about 5 weight percent; and about 0.02 to about 2 parts by weight of a polyethyleneimine having a number average molecular weight of about 100 to about 10,000 atomic mass units; wherein all parts by weight are based on 100 parts by weight total of the poly(arylene ether) and the maleic-anhydride functionalized block copolymer.

One embodiment is the product obtained on melt-kneading a composition consisting essentially of a poly(arylene ether); an acid-functionalized block copolymer of an alkenyl aromatic monomer and a conjugated diene; a polyamine compound; optionally, a filler selected from the group consisting of silica powder, fused silica, crystalline silica, natural silica sand, boron-nitride powder, boron-silicate powder, alumina, magnesium oxide, wollastonite, calcium sulfate, calcium carbonate, talc, glass spheres, kaolin, mica, feldspar, nepheline syenite, silicate spheres, flue dust, cenospheres, fillite, aluminosilicate, quartz, quartzite, perlite, Tripoli, diatomaceous earth, silicon carbide, molybdenum sulfide, zinc sulfide, mullite, calcium silicate, zirconium silicate, barium titanate, barium ferrite, barium sulfate, aluminum, bronze, zinc, copper, nickel, carbon black, graphite, glass flakes, flaked silicon carbide, flaked aluminum diboride, aluminum flakes, steel flakes, wood flour, cellulose, cotton, sisal, jute, starch, cork flour, lignin, ground nut shells, corn, rice grain husks, polyester fibers, polyvinylalcohol fibers, aromatic polyamide fibers, polybenzimidazole fibers, polyimide fibers, polyphenylene sulfide fibers, polyether ether ketone fibers, boron fibers, silicon carbide fibers, mixed oxide fibers, silicon carbide fibers, alumina fibers, boron carbide fibers, iron fibers, nickel fibers, copper fibers, glass fibers, quartz, vapor-grown carbon fibers, and combinations thereof; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

One embodiment is the product obtained on melt-kneading a composition consisting of a poly(arylene ether); an acid-functionalized block copolymer of an alkenyl aromatic monomer and a conjugated diene; a polyamine compound; optionally, a filler selected from the group consisting of silica powder, fused silica, crystalline silica, natural silica sand, boron-nitride powder, boron-silicate powder, alumina, magnesium oxide, wollastonite, calcium sulfate, calcium carbonate, talc, glass spheres, kaolin, mica, feldspar, nepheline syenite, silicate spheres, flue dust, cenospheres, fillite, aluminosilicate, quartz, quartzite, perlite, Tripoli, diatomaceous earth, silicon carbide, molybdenum sulfide, zinc sulfide, mullite, calcium silicate, zirconium silicate, barium titanate, barium ferrite, barium sulfate, aluminum, bronze, zinc, copper, nickel, carbon black, graphite, glass flakes, flaked silicon carbide, flaked aluminum diboride, aluminum flakes, steel flakes, wood flour, cellulose, cotton, sisal, jute, starch, cork flour, lignin, ground nut shells, corn, rice grain husks, polyester fibers, polyvinylalcohol fibers, aromatic polyamide fibers, polybenzimidazole fibers, polyimide fibers, polyphenylene sulfide fibers, polyether ether ketone fibers, boron fibers, silicon carbide fibers, mixed oxide fibers, silicon carbide fibers, alumina fibers, boron carbide fibers, iron fibers, nickel fibers, copper fibers, glass fibers, quartz, vapor-grown carbon fibers, and combinations thereof; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

The invention includes the compositions prior to melt-kneading. Thus, one embodiment is a composition comprising a poly(arylene ether), an acid-functionalized block copolymer of an alkenyl aromatic monomer and a conjugated diene, and a polyamine compound. Another embodiment is a composition, comprising a poly(arylene ether) comprising 2,6-dimethyl-1,4-phenylene ether units, 2,3,6-trimethyl-1,4-phenylene ether units, or a combination thereof; a maleic-anhydride functionalized polystyrene-poly(ethylene-butylene)-polystyrene triblock copolymer having a styrene content of about 10 to about 50 weight percent and a bound maleic anhydride content of about 0.2 to about 5 weight percent; and a polyethyleneimine having a number average molecular weight of about 100 to about 10,000 atomic mass units. Another embodiment is a composition, comprising: about 50 to about 95 parts by weight of a poly(arylene ether) comprising 2,6-dimethyl-1,4-phenylene ether units, 2,3,6-trimethyl-1,4-phenylene ether units, or a combination thereof; about 5 to about 50 parts by weight of a maleic-anhydride functionalized polystyrene-poly(ethylene-butylene)-polystyrene triblock copolymer having a styrene content of about 10 to about 50 weight percent and a bound maleic anhydride content of about 0.2 to about 5 weight percent; and about 0.02 to about 2 parts by weight of a polyethyleneimine having a number average molecular weight of about 100 to about 10,000 atomic mass units; wherein all parts by weight are based on 100 parts by weight total of the poly(arylene ether) and maleic-anhydride functionalized polystyrene-poly(ethylene-butylene)-polystyrene triblock copolymer.

The invention further extends to methods of melt-kneading a thermoplastic composition. Thus, one embodiment is a method of preparing a composition, comprising melt-kneading a poly(arylene ether), an acid-functionalized block copolymer of an alkenyl aromatic monomer and a conjugated diene, and a polyamine compound.

The composition may be prepared by any method in which the poly(arylene ether), the acid-functionalized block copolymer, and the polyamine compound are ultimately melt-kneaded with each other. In one embodiment, the acid-functionalized block copolymer and polyamine compound are melt-kneaded with each other before being further melt-kneaded with the poly(arylene ether). In another embodiment, the polyamine compound and the poly(arylene ether) are melt-kneaded with each other before being further melt-kneaded with the acid-functionalized block copolymer. In yet another embodiment, the acid-functionalized block copolymer and the poly(arylene ether) are melt-kneaded with each other before being further melt-kneaded with the polyamine compound. In still another embodiment, the acid-functionalized block copolymer, the polyamine compound, and the poly(arylene ether) are all melt-kneaded simultaneously (for example, the three components are all added at the feed throat of an extruder). Apparatus suitable for preparing an intimate blend via melt-kneading includes, for example, a two-roll mill, a Banbury mixer, and a single-screw or twin-screw extruder. In one embodiment, melt-kneading comprises using a twin-screw extruder.

Other embodiments include articles formed from the melt-kneaded compositions. For example, an article may comprise a film, sheet, molded object, or composite, wherein the film, sheet, molded object or composite comprises at least one layer comprising the composition. Articles may be prepared from the composition using fabrication methods known in the art, including, for example, single layer and multilayer foam extrusion, single layer and multilayer sheet extrusion, injection molding, blow molding, extrusion, film extrusion, profile extrusion, pultrusion, compression molding, thermoforming, pressure forming, hydroforming, vacuum forming, foam molding, and the like. Combinations of the foregoing article fabrication methods may be used. Specific articles for which the composition may be useful include, for example, fluid engineering articles such as pump impellers, pump housings, pump covers, water meters, hydroblocks, fittings, water treatment equipment, pool and spa components, manifolds, and valves.

The invention is further illustrated by the following non-limiting examples.

### EXAMPLES 1-9, COMPARATIVE EXAMPLES 1-3

These examples demonstrate the effects of varying the concentrations of poly(arylene ether), acid-functionalized block copolymer, and polyamine crosslinker. The poly(arylene ether) (“PPE”) was a poly(2,6-dimethyl-1,4-phenylene ether) having an initial intrinsic viscosity of about 0.33 deciliter per gram, obtained from GE Plastics. The acid-functionalized block copolymer (“Acid-fxnd. copolymer”) was a maleic anhydride-grafted, hydrogenated polystyrene-poly(ethylene-butylene)-polystyrene triblock copolymer having a styrene content of 30% and about 1.4-2.0% bound maleic anhydride, obtained as KRATON®& FG1901X from Kraton Polymers. The polyamine was a polyethyleneimine having a number average molecular weight of about 10,000 atomic mass units, obtained as EPOMIN® SP-200. Component amounts are presented in Table 1.

The crosslinking of the acid-functionalized block copolymer and blending of all components were conducted simultaneously in a melt-kneading process. A dry blend containing the poly(arylene ether), the polyamine crosslinking agent, and the acid-functionalized block copolymer were added in the feed throat in a 30-millimeter, 10-zone twin-screw extruder operating at 350 rotations per minute with barrel temperatures from feed throat to die of 260° C., 290° C., 300° C., and 300° C. The twin-screw extruder uses a down stream feeder in zone 7 out of 10 zones. A vacuum vent is located in zone 10 with 20-25 inches of mercury vacuum being applied. The feed rate was about 16-18 kilograms per hour (35-40 pounds per hour). The screw design employed had fairly intensive mixing in zones 2 to 4 with relatively mild mixing in zone 9. The extrudate was cooled and pelletized. Test samples were injection molded using a barrel temperature of 300° C. and a mold temperature of 95° C.

Flexural modulus was measured according to ASTM D 790 Method A at 23° C. using samples having a depth of 3.2 millimeters and a width of 12.7 millimeters, a support span length of 5.08 centimeters (2 inches), and a crosshead motion rate of 1.27 millimeter/minute (0.05 inch/minute). Notched Izod impact strength was measured according to ASTM D 256 Method A at 23° C. using a 0.907 kilogram (2.00 pound) hammer, and specimens having a notch such that at least 1.02 centimeter (0.4 inch) of the original 1.27 centimeter (0.5 inch) depth remained under the notch; the specimens were conditioned for 24 hours at 23° C. after notching. Heat deflection temperature was measured according to ASTM D 648, Method B on injection molded specimens having a width of 3.20 millimeters and a depth of 12.80 millimeters. Specimens were conditioned for 24 hours at 23° C. before testing. For heat deflection testing, samples were immersed in silicone oil, which was initially at less than 30° C. The standard deviation for each property value represents evaluation of three samples per test. Property values are given in Table 1.

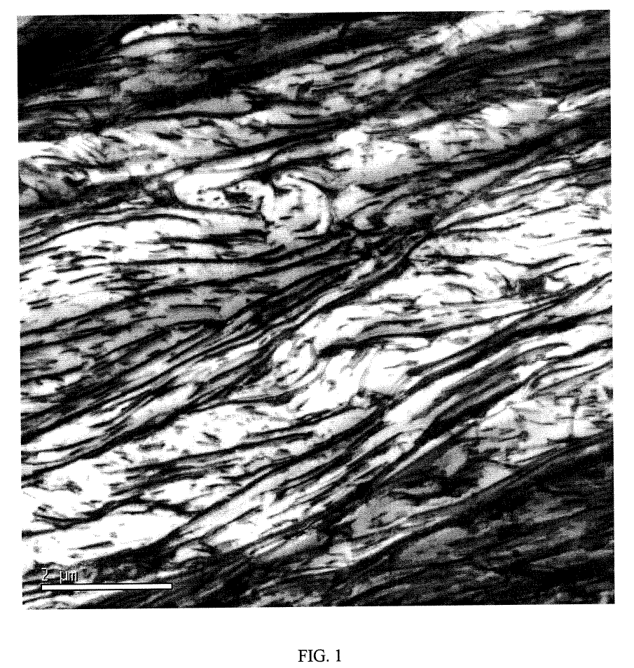

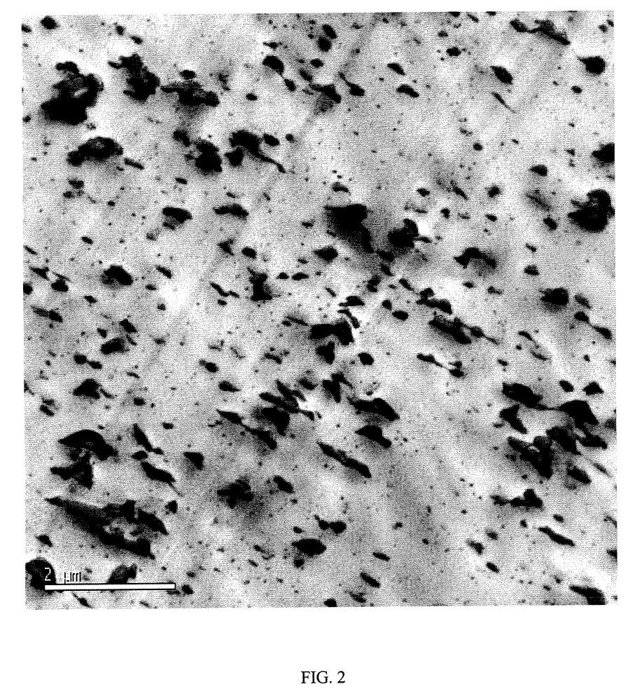

The results show that, relative to the corresponding comparative examples without polyamine, all of the inventive compositions exhibit unexpectedly improved stiffness (flexural modulus) and heat resistance (heat deflection temperature). Inventive samples with higher concentrations of acid-functionalized copolymer and polyamine (Exs. 8 and 9) also exhibited unexpectedly improved impact strength (notched Izod). Although some of the comparative examples exhibited superior notched Izod impact strength relative to the inventive samples, those comparative examples exhibited a lamellar morphology that makes molded parts susceptible to delamination. Also, the anisotropic nature of the lamellar structure makes it difficult to design molded parts using these compositions. For example, FIGS. 1 and 2 are transmission electron micrographs corresponding to Comparative Example 1 and Example 1, respectively. Samples were prepared by cutting, blocking and facing a molded tensile bar on a Leica UCT ultramicrotome. Final microtomy of 100 nanometer sections was performed on the Leica UCT at room temperature. The sections were stained in ruthenium tetroxide staining solution for 45 seconds, which stains the rubber regions in preference to the poly(arylene ether) regions. Microscopy was performed on a Philips Tecnai transmission electron microscope. Digital image acquisition was achieved using a Gatan Model 791 side mount CCD camera. FIG. 1 shows that the Comparative Example 1 composition had a lamellar morphology. FIG. 2 shows that the Example 1 composition had a morphology in which discrete rubber domains were dispersed in a poly(arylene ether) matrix.

TABLE 1

| | | | |
|---|---|---|---|
| C. Ex. 1 | Ex. 1 | Ex. 2 | Ex. 3 |

Compositions

| | | | | |
|---|---|---|---|---|
| PPE | 90 | 90 | 90 | 90 |
| Acid-fxnd. | 10 | 10 | 10 | 10 |
| copolymer | | | | |
| Polyamine | 0 | 0.0625 | 0.125 | 0.25 |

Properties

| Flexural | 1850 ± 34 | 1940 ± 40 | 1960 ± 35 | 1970 ± 19 |
|---|---|---|---|---|
| Modulus (MPa) | | | | |
| Notched | 399 ± 29 | 387 ± 8 | 419 ± 19 | 407 ± 42 |
| Izod (J/m) | | | | |
| Heat Deflection | 176 ± 1 | 179 ± 1 | 180 ± 0.3 | 180 ± 1 |
| (° C.) | | | | |
| | C. Ex. 2 | Ex. 4 | Ex. 5 | Ex. 6 |

Compositions

| | | | | |
|---|---|---|---|---|
| PPE | 85 | 85 | 85 | 85 |
| Acid-fxnd. | 15 | 15 | 15 | 15 |
| copolymer | | | | |
| Polyamine | 0 | 0.0625 | 0.125 | 0.25 |

Properties

| Flexural | 1520 ± 13 | 1650 ± 23 | 1780 ± 24 | 1780 ± 7 |
|---|---|---|---|---|
| Modulus (MPa) | | | | |
| Notched | 565 ± 203 | 479 ± 15 | 478 ± 19 | 488 ± 6 |
| Izod (J/m) | | | | |
| Heat Deflection | 167 ± 3 | 173 ± 1 | 177 ± 1 | 177 ± 1 |
| (° C.) | | | | |
| | C. Ex. 3 | Ex. 7 | Ex. 8 | Ex. 9 |

Compositions

| | | | | |
|---|---|---|---|---|
| PPE | 80 | 80 | 80 | 80 |
| Acid-fxnd. | 20 | 20 | 20 | 20 |
| copolymer | | | | |
| Polyamine | 0 | 0.0625 | 0.125 | 0.25 |

Properties

| | | | | |
|---|---|---|---|---|
| Flexural | 1220 ± 20 | 1410 ± 26 | 1470 ± 47 | 1540 ± 13 |
| Modulus (MPa) | | | | |
| Notched | 373 ± 63 | 452 ± 89 | 512 ± 25 | 519 ± 25 |
| Izod (J/m) | | | | |
| Heat Deflection | 147 ± 3 | 164 ± 4 | 177 ± 1 | 172 ± 1 |
| (° C.) | | | | |

### EXAMPLES 10-14, COMPARATIVE EXAMPLES 4-8

These examples illustrate that compositions prepared from a poly(arylene ether), an acid-functionalized block copolymer, a polyamine crosslinker, and a filler exhibit surprisingly improved (reduced) shrinkage on molding and after further exposure to elevated temperature. Component types and parts by weight are presented in Table 2. The poly(arylene ether) and acid-functionalized block copolymer were the same as those used in Examples 1-9. The polyamine was a polyethyleneimine having a number average molecular weight of about 600 atomic mass units, obtained as EPOMIN® SP-006. An unfunctionalized poly(styrene-ethylene/butylene-styrene) triblock copolymer (“Unfxnd. copolymer” in Table 2) having a styrene content of 30% was obtained as KRATON® G 1652 from Kraton Polymers. An antioxidant, tris(2,4-di-t-butylphenyl) phosphite (TDBPP), was obtained as IRGAFOS® 168 from Ciba Specialty Chemicals. A second antioxidant, tridecyl phosphite (TDP), was obtained from Dover Chemical Company. Carbon fibers having a diameter of about 7 micrometers and a length before melt-kneading of about 0.65 centimeter were obtained as FORTAFIL 202 from Akzo Nobel. Delaminated phlogopite mica having a median equivalent spherical diameter of 45 micrometers was obtained as Suzorite 200-HK from Zemex Industrial Minerals.

Compositions were compounded and molded as described for Examples 1-9. Shrinkage values were determined at room temperature (23° C.) on samples as-molded and after 5.5 and 39 hours in a 150° C. oven. Cross-flow shrinkage (i.e., the degree of shrinkage in the dimension perpendicular to the dimension along which the composition flows into the mold) was measured using round plaques having a diameter of 10.16 centimeters (4 inches) and a thickness of 3.175 millimeters (0.125 inch). Percent cross-flow shrinkage, expressed in parts per million (ppm), was calculated as 10⁶*(mold diameter−sample diameter)/(mold diameter). In-flow shrinkage (i.e., the degree of shrinkage in the dimension along which the composition flows into the mold) was measured using rectangular plaques having a length of 12.7 centimeters (5 inches), a width of 1.27 centimeters (0.5 inch), and a thickness of 3.175 millimeters (0.125 inch). Percent cross-flow shrinkage, expressed in parts per million (ppm), was calculated as 10⁶*(mold length−sample length)/(mold length).

The results, presented in Table 2, show that for unfilled compositions, the compositions with acid-functionalized copolymer and polyamine (i.e., with crosslinked rubber) exhibited greater shrinkage than the composition with unfunctionalized copolymer (i.e., with uncrosslinked rubber). However, for the compositions filled with carbon fiber or mica, the compositions with acid-functionalized copolymer and polyamine exhibited lower shrinkage than the composition with unfanctionalized copolymer (i.e., with uncrosslinked rubber). So, there is a surprising shrinkage-reducing synergy associated with using the crosslinked rubber in filled compositions.

TABLE 2

| | | | |
|---|---|---|---|
| Ex. 10 | C. Ex. 4 | Ex. 11 | C. Ex. 5 |

Compositions

| | | | | |
|---|---|---|---|---|
| PPE | 88.4 | 88.7 | 78.4 | 78.7 |
| Acid-fxnd. copolymer | 10 | 0 | 20 | 0 |
| Unfxnd. copolymer | 0 | 10 | 0 | 20 |
| Polyamine | 0.3 | 0 | 0.3 | 0 |
| Antioxidant, TDBPP | 0.5 | 0.5 | 0.5 | 0.5 |
| Antioxidant, TDP | 0.8 | 0.8 | 0.8 | 0.8 |
| Carbon fiber | 0 | 0 | 0 | 0 |
| Mica | 0 | 0 | 0 | 0 |

Properties

| Cross-flow shrinkage, as molded | 296.9 | 257.5 | 325.6 | 275.0 |
|---|---|---|---|---|
| (ppm) | | | | |
| Cross-flow shrinkage, 5.5 h at | 327.5 | 278.7 | 351.2 | 309.4 |
| 150° C. (ppm) | | | | |
| Cross-flow shrinkage, 39 h at | 331.3 | 278.7 | 346.2 | 313.7 |
| 150° C. (ppm) | | | | |
| In-flow shrinkage, as molded | 215.2 | 179.2 | 219.2 | 183.6 |
| (ppm) | | | | |
| In-flow shrinkage, 5.5 h at | 238.0 | 199.6 | 246.8 | 213.2 |
| 150° C. (ppm) | | | | |
| In-flow shrinkage, 39 h at | 237.2 | 202.8 | 249.2 | 219.6 |
| 150° C. (ppm) | | | | |
| | Ex. 12 | C. Ex. 6 | Ex. 13 | C. Ex. 7 |

Compositions

| | | | | |
|---|---|---|---|---|
| PPE | 81.3 | 81.6 | 72.1 | 72.4 |
| Acid-fxnd. copolymer | 9.2 | 0 | 18.4 | 0 |
| Unfxnd. copolymer | 0 | 9.2 | 0 | 18.4 |
| Polyamine | 0.276 | 0 | 0.276 | 0 |
| Antioxidant, TDBPP | 0.5 | 0.5 | 0.5 | 0.5 |
| Antioxidant, TDP | 0.8 | 0.8 | 0.8 | 0.8 |
| Carbon fiber | 8.0 | 8.0 | 8.0 | 8.0 |
| Mica | 0 | 0 | 0 | 0 |

Properties

| | | | | |
|---|---|---|---|---|
| Cross-flow shrinkage, as molded | 153.8 | 164.4 | 175.0 | 177.5 |
| (ppm) | | | | |
| Cross-flow shrinkage, 5.5 h at | 175.6 | 191.2 | 181.9 | 197.5 |
| 150° C. (ppm) | | | | |
| Cross-flow shrinkage, 39 h at | 175.0 | 192.5 | 185.0 | 205.0 |
| 150° C. (ppm) | | | | |
| In-flow shrinkage, as molded | 88.0 | 94.0 | 86.0 | 108.4 |
| (ppm) | | | | |
| In-flow shrinkage, 5.5 h at | 94.4 | 111.2 | 96.8 | 127.6 |
| 150° C. (ppm) | | | | |
| In-flow shrinkage, 39 h at | 95.2 | 117.2 | 98.4 | 137.6 |
| 150° C. (ppm) | | | | |

| | |
|---|---|
| Ex. 14 | C. Ex. 6 |

Compositions

| | | |
|---|---|---|
| PPE | 75.1 | 72.4 |
| Acid-fxnd. copolymer | 18.4 | 0 |
| Unfxnd. copolymer | 0 | 18.4 |
| Polyamine | 0.276 | 0 |
| Antioxidant, TDBPP | 0.5 | 0.5 |
| Antioxidant, TDP | 0.8 | 0.8 |
| Carbon fiber | 0 | 0 |
| Mica | 10 | 10 |

Properties

| | | |
|---|---|---|
| Cross-flow shrinkage, as molded (ppm) | 272.5 | 273.8 |
| Cross-flow shrinkage, 5.5 h at 150° C. (ppm) | 272.5 | 273.8 |
| Cross-flow shrinkage, 39 h at 150° C. (ppm) | 301.3 | 323.1 |
| In-flow shrinkage, as molded (ppm) | 180.4 | 185.6 |
| In-flow shrinkage, 5.5 h at 150° C. (ppm) | 200.4 | 214.4 |
| In-flow shrinkage, 39 h at 150° C. (ppm) | 206.0 | 221.6 |

### EXAMPLES 15 and 16, COMPARATIVE EXAMPLES 7 AND 8

These examples demonstrate the remarkable and unexpected improvements in knit line strength exhibited by the present compositions. A knit line is a surface where two resin flows meet within a molded part. Knit lines are often unavoidable features of articles formed in molds with complex shapes, but the knit lines can be the weakest parts of those articles. It is therefore desirable to increase knit line strength in order to increase the physical strength of molded articles. In these experiments, tensile bars were molded in a tool that allows resin to enter from both ends of the cavity. This results in two flow fronts that meet in a knit line at the center of the tensile bar. The tensile bars, corresponding to ASTM D 638-03 Type I, had cross-sectional dimensions of 13 millimeters by 3.2 millimeters at the knit line. They were injection molded in a 120 Ton Van Dom injection molding machine using a barrel temperature of 310° C., a mold temperature of 95° C., a pressure of 10.34 megapascals (1500 pounds per square inch), and an injection velocity of 8.89 centimeters/second (3.5 inches/second). Tensile bars were conditioned for at least 24 hours at 23° C. between molding and testing.

Four compositions were tested. All four compositions included a poly(2,6-dimethyl-1,4-phenylene ether) having an initial intrinsic viscosity of 0.33 deciliter per gram obtained from General Electric Company and a maleic anhydride-grafted, hydrogenated polystyrene-poly(ethylene-butylene)-polystyrene triblock copolymer having a styrene content of 30% and about 1.4-2.0% bound maleic anhydride obtained as KRATON® FG1901X from Kraton Polymers. Two of the compositions, Examples 15 and 16, additionally contained a polyethyleneimine having a number average molecular weight of about 600 atomic mass units, obtained as EPOMIN® SP-006. Compositions are detailed in Table 3. For the resulting tensile bars, tensile strengths at yield were measured at 25° C. according to ASTM D 638-03 using five samples per composition and a testing speed of 5.08 centimeters/minute (2 inches/minute). The results, presented in Table 3, show that addition of the polyamine crosslinker dramatically and unexpectedly increased the tensile strength at yield, which is a measure of the knit line strength because of the way the samples were molded. Specifically, addition of polyamine to a sample containing about 80 weight percent poly(arylene ether) and about 20 weight percent acid-functionalized block copolymer increased the tensile strength at yield from 2.19 megapascals to 24.2 megapascals; and addition of polyamine to a sample containing about 90 weight percent poly(arylene ether) and about 10 weight percent acid-functionalized block copolymer increased the tensile strength at yield from 8.24 megapascals to 23.6 megapascals.

TABLE 3

| | | | |
|---|---|---|---|
| C. Ex. 7 | Ex. 15 | C. Ex. 8 | Ex. 16 |

Compositions

| | | | | |
|---|---|---|---|---|
| PPE | 80 | 79.75 | 90 | 89.75 |
| Acid-fxnd. copolymer | 20 | 20 | 10 | 10 |
| Polyamine | 0 | 0.25 | 0 | 0.25 |

Property

| | | | | |
|---|---|---|---|---|
| Tensile Yield (MPa) | 2.19 | 24.2 | 8.24 | 23.6 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A composition comprising the product obtained on melt-kneading
a poly(arylene ether);
an acid-functionalized block copolymer of an alkenyl aromatic monomer and a conjugated diene; and
a polyamine compound.

2. The composition of claim 1, wherein the composition exhibits
a flexural modulus of at least 1400 megapascals, measured at 23° C. according ASTM D 790, and
a heat deflection temperature of at least 165° C. according to ASTM D 648.

3. The composition of claim 1, wherein the composition exhibits
a flexural modulus of about 1400 to about 2000 megapascals, measured at 23° C. according ASTM D 790, and
a heat deflection temperature of about 165 to about 180° C. according to ASTM D 648.

4. The composition of claim 1, comprising a dispersed phase having a number average particle diameter of about 0.1 to about 2 micrometers.

5. The composition of claim 1, wherein the poly(arylene ether) comprises repeating structural units having the formula 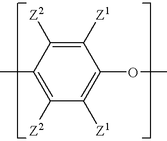
wherein for each structural unit, each Z¹ is independently halogen, unsubstituted or substituted C₁-C₁₂ hydrocarbyl with the proviso that that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

6. The composition of claim 1, wherein the poly(arylene ether) comprises 2,6-dimethyl-1,4-phenylene ether units, 2,3,6-trimethyl-1,4-phenylene ether units, or a combination thereof.

7. The composition of claim 1, wherein the poly(arylene ether) comprises a maleic anhydride-functionalized poly(arylene ether).

8. The composition of claim 1, wherein the acid-functionalized block copolymer is the product of functionalizing an unhydrogenated or hydrogenated block copolymer of an alkenyl aromatic compound and a conjugated diene with a functionalizing agent selected from the group consisting of maleic acid, maleic anhydride, methyl maleic acid, methyl maleic anhydride, dimethyl maleic acid, dimethyl maleic anhydride, monochloro maleic acid, monochloro maleic anhydride, dichloro maleic acid, dichloro maleic anhydride, 5-norbornene-2,3-dicarboxylic acids, 5-norbornene-2,3-dicarboxylic acid anhydrides, tetrahydrophthalic acids, tetrahydrophthalic anhydrides, fumaric acid, itaconic acid, itaconic anhydride, citraconic acid, citraconic anhydride, trimellitic acid, trimellitic acid anhydride, trimellitic anhydride acid chloride, and mixtures thereof.

9. The composition of claim 1, wherein the acid-functionalized block copolymer is a maleic anhydride-functionalized linear block copolymer or radial teleblock copolymer of styrene and a conjugated diene selected from the group consisting of butadiene, isoprene, and combinations thereof; wherein the an acid-functionalized block copolymer has a styrene content of about 10 to about 50 weight percent.

10. The composition of claim 1, wherein the acid-functionalized block copolymer is a maleic anhydride-functionalized polystyrene-poly(ethylene-butylene)-polystyrene triblock copolymer having a styrene content of about 10 to about 50 weight percent or a maleic anhydride-functionalized polystyrene-poly(ethylene-butylene) diblock copolymer having a styrene content of about 10 to about 50 weight percent.

11. The composition of claim 1, wherein the polyamine compound comprises (a) at least three amine groups selected from the group consisting of primary amine groups, secondary amine groups, and combinations thereof, and (b) at least one C₂-C₆ alkylene group optionally substituted with one or more ether oxygen atoms.

12. The composition of claim 1, wherein the polyamine compound is selected from the group consisting of polyetheramines, polyalkyleneimines, polyalkyleneamines, and mixtures thereof.

13. The composition of claim 1, wherein the polyamine compound is a polyalkyleneimine.

14. The composition of claim 1, wherein the polyamine compound is a polyethyleneimine having a number average molecular weight of about 100 to about −1,000,000 atomic mass units.

15. The composition of claim 1, wherein the composition before melt-kneading comprises about 20 to about 99 parts by weight of the poly(arylene ether), about 1 to about 80 parts by weight of the acid-functionalized block copolymer, and about 0.01 to about 5 parts by weight of the polyamine, wherein all parts by weight are based on 100 parts by weight total of the poly(arylene ether) and the acid-functionalized block copolymer

16. The composition of claim 1, wherein the composition before melt-kneading further comprises an atactic homopolystyrene, a rubber-modified polystyrene, or a mixture thereof.

17. The composition of claim 1, wherein the composition before melt-kneading further comprises a filler selected from the group consisting of silica powder, fused silica, crystalline silica, natural silica sand, boron-nitride powder, boron-silicate powder, alumina, magnesium oxide, wollastonite, calcium sulfate, calcium carbonate, talc, glass spheres, kaolin, mica, feldspar, nepheline syenite, silicate spheres, flue dust, cenospheres, fillite, aluminosilicate, quartz, quartzite, perlite, Tripoli, diatomaceous earth, silicon carbide, molybdenum sulfide, zinc sulfide, mullite, calcium silicate, zirconium silicate, barium titanate, barium ferrite, barium sulfate, aluminum, bronze, zinc, copper, nickel, carbon black, graphite, glass flakes, flaked silicon carbide, flaked aluminum diboride, aluminum flakes, steel flakes, wood flour, cellulose, cotton, sisal, jute, starch, cork flour, lignin, ground nut shells, corn, rice grain husks, polyester fibers, polyvinylalcohol fibers, aromatic polyamide fibers, polybenzimidazole fibers, polyimide fibers, polyphenylene sulfide fibers, polyether ether ketone fibers, boron fibers, silicon carbide fibers, mixed oxide fibers, silicon carbide fibers, alumina fibers, boron carbide fibers, iron fibers, nickel fibers, copper fibers, glass fibers, quartz, vapor-grown carbon fibers, and combinations thereof.

18. The composition of claim 1, wherein the composition before melt-kneading further comprises an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

19. The composition of claim 1, wherein the composition is substantially free of any thermoplastic or thermoset resin other than the poly(arylene ether) and the acid-functionalized block copolymer.

20. A composition comprising the product obtained on melt-kneading
a poly(arylene ether) comprising 2,6-dimethyl-1,4-phenylene ether units, 2,3,6-trimethyl-1,4-phenylene ether units, or a combination thereof;
a maleic-anhydride functionalized, hydrogenated block copolymer comprising at least one polystyrene block and at least one hydrogenated poly(conjugated diene) block, and having a styrene content of about 10 to about 50 weight percent and a bound maleic anhydride content of about 0.2 to about 5 weight percent; and
a polyethyleneimine having a number average molecular weight of about 100 to about 10,000 atomic mass units.

21. A composition comprising the product obtained on melt-kneading about 50 to about 95 parts by weight of a poly(arylene ether) comprising 2,6-dimethyl-1,4-phenylene ether units, 2,3,6-trimethyl-1,4-phenylene ether units, or a combination thereof;
about 5 to about 50 parts by weight of a maleic-anhydride functionalized block copolymer selected from the group consisting of polystyrene-poly(ethylene-butylene)-polystyrene triblock copolymer, polystyrene-poly(ethylene-propylene)-polystyrene triblock copolymer, and mixtures thereof; wherein the maleic-anhydride functionalized block copolymer has a styrene content of about 10 to about 50 weight percent and a bound maleic anhydride content of about 0.2 to about 5 weight percent; and
about 0.02 to about 2 parts by weight of a polyethyleneimine having a number average molecular weight of about 100 to about 10,000 atomic mass units;
wherein all parts by weight are based on 100 parts by weight total of the poly(arylene ether) and the maleic-anhydride functionalized block copolymer.

22. A composition comprising the product obtained on melt-kneading a poly(arylene ether); and
the reaction product of a polyamine compound and an acid-functionalized block copolymer of an alkenyl aromatic monomer and a conjugated diene.

23. The product obtained on melt-kneading a composition consisting essentially of a poly(arylene ether);
an acid-functionalized block copolymer of an alkenyl aromatic monomer and a conjugated diene;
a polyamine compound;
optionally, a filler selected from the group consisting of silica powder, fused silica, crystalline silica, natural silica sand, boron-nitride powder, boron-silicate powder, alumina, magnesium oxide, wollastonite, calcium sulfate, calcium carbonate, talc, glass spheres, kaolin, mica, feldspar, nepheline syenite, silicate spheres, flue dust, cenospheres, fillite, aluminosilicate, quartz, quartzite, perlite, Tripoli, diatomaceous earth, silicon carbide, molybdenum sulfide, zinc sulfide, mullite, calcium silicate, zirconium silicate, barium titanate, barium ferrite, barium sulfate, aluminum, bronze, zinc, copper, nickel, carbon black, graphite, glass flakes, flaked silicon carbide, flaked aluminum diboride, aluminum flakes, steel flakes, wood flour, cellulose, cotton, sisal, jute, starch, cork flour, lignin, ground nut shells, corn, rice grain husks, polyester fibers, polyvinylalcohol fibers, aromatic polyamide fibers, polybenzimidazole fibers, polyimide fibers, polyphenylene sulfide fibers, polyether ether ketone fibers, boron fibers, silicon carbide fibers, mixed oxide fibers, silicon carbide fibers, alumina fibers, boron carbide fibers, iron fibers, nickel fibers, copper fibers, glass fibers, quartz, vapor-grown carbon fibers, and combinations thereof; and
optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

24. The product obtained on melt-kneading a composition consisting of
a poly(arylene ether);
an acid-functionalized block copolymer of an alkenyl aromatic monomer and a conjugated diene;
a polyamine compound;
optionally, a filler selected from the group consisting of silica powder, fused silica, crystalline silica, natural silica sand, boron-nitride powder, boron-silicate powder, alumina, magnesium oxide, wollastonite, calcium sulfate, calcium carbonate, talc, glass spheres, kaolin, mica, feldspar, nepheline syenite, silicate spheres, flue dust, cenospheres, finite, aluminosilicate, quartz, quartzite, perlite, Tripoli, diatomaceous earth, silicon carbide, molybdenum sulfide, zinc sulfide, mullite, calcium silicate, zirconium silicate, barium titanate, barium ferrite, barium sulfate, aluminum, bronze, zinc, copper, nickel, carbon black, graphite, glass flakes, flaked silicon carbide, flaked aluminum diboride, aluminum flakes, steel flakes, wood flour, cellulose, cotton, sisal, jute, starch, cork flour, lignin, ground nut shells, corn, rice grain husks, polyester fibers, polyvinylalcohol fibers, aromatic polyamide fibers, polybenzimidazole fibers, polyimide fibers, polyphenylene sulfide fibers, polyether ether ketone fibers, boron fibers, silicon carbide fibers, mixed oxide fibers, silicon carbide fibers, alumina fibers, boron carbide fibers, iron fibers, nickel fibers, copper fibers, glass fibers, quartz, vapor-grown carbon fibers, and combinations thereof; and
optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

25. A composition, comprising:
a poly(arylene ether);
an acid-functionalized block copolymer of an alkenyl aromatic monomer and a conjugated diene; and
a polyamine compound.

26. A method of preparing a composition, comprising melt-kneading a poly(arylene ether), an acid-functionalized block copolymer of an alkenyl aromatic monomer and a conjugated diene, and a polyamine compound.

27. An article comprising the composition of claim 1.

28. An article comprising the composition of claim 20.

29. An article comprising the composition of claim 21.
